(19) United States
(12) Patent Application Publication
(10) Pub. No.: US 2012/0064233 A1
(43) Pub. Date: Mar. 15, 2012

(54) Apparatus And Method For Manufacturing MMO Anode Using Continuous Coating And Heat Treatment Process

(76) Inventors: Jung-Chul KIM, Gyeonggi-do (KR); Dong-Woon Han, Gyeonggi-do (KR); Ki-Ik Kim, Gyeonggi-do (KR); Jung-Sik Kim, Chungcheongbuk-do (KR); Young-Jun Kim, Daejeon (KR); Jeong-Hyun Lee, Chungcheongbuk-do (KR)

(21) Appl. No.: 13/227,295

(22) Filed: Sep. 7, 2011

(30) Foreign Application Priority Data
Sep. 15, 2010 (KR) 10-2010-0090335

(51) Int. Cl. B05D 5/12; B05C 13/02; B05C 3/12; B05C 11/00

(52) U.S. Cl. 427/117; 427/126.3; 118/67

(57) ABSTRACT

Disclosed is a method of manufacturing an MMO anode using reel-to-reel continuous coating and heat treatment, including continuously coating a surface of a metal substrate with an MMO (Mixed Metal Oxide) coating solution using a continuous coater and passing the metal substrate through a heat pretreatment furnace and a heat treatment furnace to form an MMO coating layer on the surface of the metal substrate. When a long wire type MMO anode is manufactured, a uniform coating layer is formed thanks to the use of reel-to-reel continuous coating and heat treatment under uniform conditions, thus increasing durability and quality of the long wire type MMO anode. The exposure time of the metal substrate to the outside between the processes is minimized, and productivity is increased, thus decreasing the manufacturing cost to result in high product competitiveness.

### BACKGROUND OF THE INVENTION

1. Technical Field

The present invention relates to manufacturing of an MMO (Mixed Metal Oxide) anode having an MMO coating layer formed on the surface of a metal substrate, and more particularly to an apparatus and method for manufacturing an MMO anode using continuous coating and heat treatment, in which the coating of an MMO solution and the heat treatment are performed by a continuous process, thus enabling a long wire type MMO anode having good quality to be manufactured and increasing productivity to thereby reduce the manufacturing cost.

2. Description of the Related Art

Typically, an MMO anode is manufactured by coating a metal substrate with MMO (Mixed Metal Oxide), and is widely utilized as an electrode for electric anti-corrosion, electroplating or water treatment using electrochemical oxidation and reduction.

In the case where an MMO anode is used as an electrode providing electric anti-corrosion, it is connected to a positive (+) terminal so that anti-corrosion current is supplied in a direction opposite the direction of corrosion current, thereby preventing the corrosion of a metal structure connected to a negative (−) terminal. The MMO anode suitable for use as an electrode providing electric anti-corrosion supplies current from oxidation and reduction, and thus has to have high electrical conductivity. Furthermore, even when a large amount of current is generated, a rate of corrosion should be low to the extent that the loss of the electrode may be decreased.

FIG. 1 shows a typical process of manufacturing an MMO anode. As shown in FIG. 1, in order to manufacture the MMO anode, a base metal substrate and a coating solution are prepared (S1, S2), in which the coating solution is obtained by mixing metal chloride, nitride, hydrate, etc., which provide the precious metal element. Subsequently, a coating layer is formed on the surface of the base metal substrate by, for example, dipping the base metal substrate in the coating solution or applying the coating solution on the base metal substrate and then drying it (S3), followed by performing heat treatment (S4). As such, dipping in the coating solution or coating with the coating solution and drying (S5) and heat treatment (S6) may be repeated until the coating layer is formed to a desired thickness on the base metal substrate.

The properties of the MMO anode thus manufactured may vary depending on coating pretreatment, the kind and concentration of element added to the coating solution, and the heat treatment conditions. Hence, in order to obtain an MMO anode having superior properties, all process conditions should be strictly controlled.

FIG. 2 shows an MMO anode used in the field of electric anti-corrosion. As shown in FIG. 2, the MMO anode to be used as an electrode providing electric anti-corrosion comprises a metal substrate A and an MMO coating layer B applied on the surface of the metal substrate A. The shape of the metal substrate A may vary depending on the field that the MMO anode is applied to, and use environment.

The lifetime of the MMO anode is determined by the coating solution that is used to form the MMO coating layer B and by the thickness of the coating layer. The MMO coating layer B may be formed by any of a variety of processes, including spraying, dipping, brushing, etc.

The MMO anode may be manufactured in a variety of forms including disk, pipe, rod, etc. forms. When the MMO anode is manufactured in the form of a disk, a pipe, or a rod, the shape of the MMO anode is simple and the length thereof is not long, and thus the coating layer may be uniformly formed to some degree on the metal substrate even by conventional manufacturing methods, and thereby big problems of the quality of the MMO anode do not occur.

However, when the MMO anode is manufactured in the form of a ribbon or mesh which is a long wire type having a length of 100 m or more, it is long and thus, upon using a conventional manufacturing method, it is difficult to uniformly maintain the application conditions of the coating solution in a longitudinal direction of the metal substrate and the drying and heat treatment conditions of the coating solution, making it difficult to form a uniform coating layer in a longitudinal direction of the metal substrate.

Thus, coating non-uniformity, which may take place on the long wire type MMO anode, may shorten the service life of the MMO anode as an electrode, and cannot prevent the corrosion of an anti-corrosion target undesirably causing unexpected incidents.

Moreover, the manufacturing of the long wire type MMO anode using a conventional method requires the scale of the manufacturing apparatus to be increased, and a long period of time is required to form the coating layer, undesirably leading to a remarkable increase in the manufacturing cost.

### SUMMARY OF THE INVENTION

Accordingly, the present invention has been made keeping in mind the problems encountered in the related art and an object of the present invention is to provide an apparatus and method for manufacturing an MMO anode using a continuous reel-to-reel process, in which a continuous process is introduced to manufacture an MMO anode so that coating and heat treatment are performed on a metal substrate under uniform conditions thereby enhancing durability and performance of the MMO anode, increasing the productivity and decreasing the manufacturing cost, resulting in high product competitiveness.

An aspect of the present invention provides a method of continuously manufacturing an MMO anode, comprising continuously coating the surface of a metal substrate with an MMO coating solution using a continuous coater; and passing the metal substrate through a heat pretreatment furnace and a heat treatment furnace to form the MMO coating layer on the surface of the metal substrate.

In this aspect, continuously coating may be performed using a reel-to-reel dip coating process or a reel-to-reel roll coating process.

In this aspect, passing the metal substrate through the heat pretreatment furnace and the heat treatment furnace may be continuously performed without interruption.

In this aspect, the heat pretreatment furnace and the heat treatment furnace may be maintained at 300˜700° C., and the metal substrate may be continuously transferred at a rate of 1˜5 m/min upon heat pretreatment and the metal substrate may be continuously transferred at a rate of 0.2˜2 m/min upon drying in the heat pretreatment furnace and upon heat treatment in the heat treatment furnace.

Another aspect of the present invention provides an apparatus for continuously manufacturing an MMO anode, comprising a drawing reel having a metal substrate wound thereon; a continuous coater for applying a coating solution on the surface of the metal substrate drawn from the drawing reel; a heat pretreatment furnace disposed adjacent to a discharge side of the continuous coater so that the metal substrate is heat treated after having passed through the continuous coater; a heat treatment furnace disposed adjacent to a discharge side of the heat pretreatment furnace so that the metal substrate is heat treated after having passed through the heat pretreatment furnace; and a winding reel disposed adjacent to a discharge side of the heat treatment furnace so that the metal substrate is wound thereon after having passed through the heat treatment furnace.

In this aspect, the continuous coater may comprise a roll coater including an upper roll and a lower roll so that roll coating is performed, or a dip coater so that the metal substrate is dipped in the coating solution in a coating bath by means of a guide roll to perform dip coating.

### BRIEF DESCRIPTION OF THE DRAWINGS

The features and advantages of the present invention will be more clearly understood from the following detailed description taken in conjunction with the accompanying drawings, in which:

FIG. 1 is a flowchart showing a general process of manufacturing an MMO anode;

FIG. 2 is a view showing an MMO anode for use in an electric anti-corrosion field;

FIGS. 3A and 3B are schematic views showing an apparatus for continuously manufacturing an MMO anode according to the present invention;

FIG. 4A is a flowchart showing a process of continuously manufacturing an MMO anode according to the present invention; and

FIG. 4B is a flowchart showing a process of continuously manufacturing an MMO anode according to the present invention, in which continuous coating and heat treatment are repeated three times.

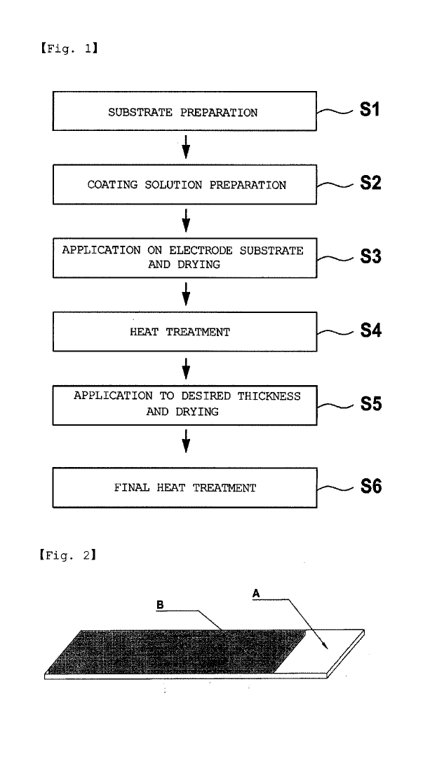

### DESCRIPTION OF SPECIFIC EMBODIMENTS

Hereinafter, preferred embodiments of the present invention are described in detail with reference to the appended drawings. However, the present invention is not limited to these embodiments and may be embodied in other forms. The embodiments disclosed herein are merely provided to make the disclosed contents thorough and complete and to transfer the spirit of the present invention in a sufficient manner to those having ordinary skill in the art.

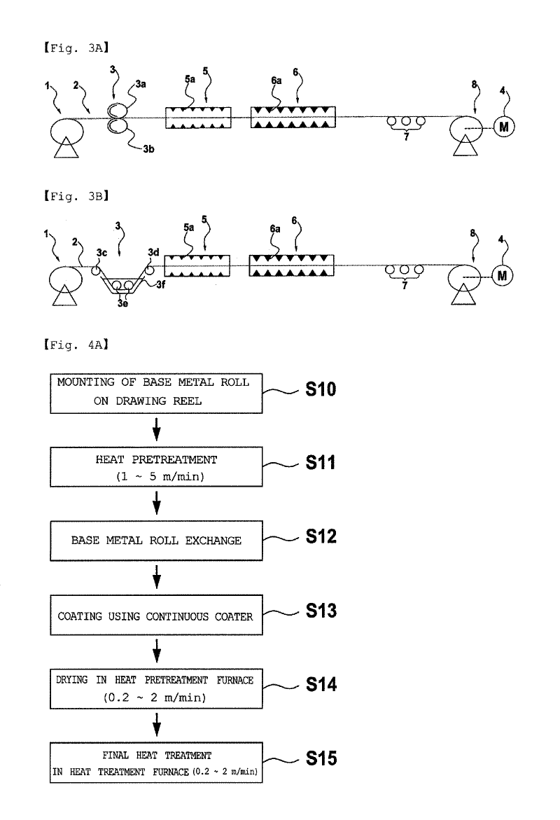

FIGS. 3A and 3B are schematic views showing an apparatus for continuously manufacturing an MMO anode according to an embodiment of the present invention. As shown in FIGS. 3A and 3B, the apparatus for continuously manufacturing the MMO anode according to the present invention comprises a drawing reel 1 having a metal substrate 2 wound thereon, a continuous coater 3 for applying a coating solution on the surface of the metal substrate 2 drawn from the drawing reel 1, a heat pretreatment furnace 5 disposed adjacent to the discharge side of the continuous coater 3 so that the metal substrate is heat treated after having passed through the continuous coater 3, a heat treatment furnace 6 disposed adjacent to the discharge side of the heat pretreatment furnace 5 so that the metal substrate is heat treated after having passed through the heat pretreatment furnace 5, and a winding reel 8 disposed adjacent to the discharge side of the heat treatment furnace 6 so that the metal substrate is wound thereon after having passed through the heat treatment furnace 6.

The apparatus for continuously manufacturing the MMO anode according to the present invention is advantageous because coating and heat treatment are continuously performed by means of a reel-to-reel process using the drawing reel 1 provided to one end of the apparatus and the winding reel 8 provided to the other end thereof. The drawing reel 1 has a long wire type metal substrate wound thereon, and the winding reel 8 is connected to the driving shaft of a driving motor 4 so as to be rotated. Also, the drawing reel 1 may be connected to the driving shaft of a driving motor which is not shown so as to be rotated.

The continuous coater 3 causes the surface of the metal substrate to be coated with the MMO coating solution while the metal substrate unwound from the drawing reel 1 passes therethrough. Such a continuous coater may include an upper roll and a lower roll so that coating is carried out using a roll coating process or may be configured such that the metal substrate is dipped in the coating solution in a coating bath by means of guide rolls so that coating is performed using a dipping process. However, the present invention is not limited thereto and a variety of coating devices may be utilized.

FIG. 3A shows a manufacturing apparatus using a roll coating process. When the continuous coater 3 is embodied so as to be adapted for roll coating, the upper roll 3a and the lower roll 3b are provided so as to come into contact with the upper surface and the lower surface of the metal substrate. Furthermore, there may be provided a coating unit such as a coating solution supplier for supplying a predetermined amount of the coating solution on the upper roll 3a while the upper roll 3a and the lower roll 3b are rotated in opposite directions to each other by means of the operation of a roll driving motor (not shown).

FIG. 3B shows a manufacturing apparatus using a dip coating process. When the continuous coater 3 is embodied so as to be adapted for dip coating, guide rolls 3c, 3d, 3e are used so that the metal substrate 2 is dipped in the coating solution in a dipping bath 3f, thus supplying the coating solution on the metal substrate 2.

In order to form the coating layer under uniform conditions on the surface of the metal substrate upon continuous coating and heat treatment, roll coating or dip coating is regarded as very appropriate. This is because the roll coating process merely requires that the driving rate of the upper and lower rolls 3a, 3b and the amount of the coating solution supplied on the upper roll 3a both be subjected to persistent control, and also because the dip coating process merely requires persistently controlling the dipping time of the metal substrate.

The heat pretreatment furnace 5 functions to perform linear heat pretreatment to prevent stripping from occurring when the MMO coating layer is formed, and has an inlet provided on one side thereof for feeding the metal substrate passed through the continuous coater 3, and an outlet provided on the other side thereof for discharging the metal substrate heat treated in the heat pretreatment furnace 5. The heat pretreatment furnace 5 may have a heating unit such as a heater 5a disposed in a longitudinal direction therein.

The heat treatment furnace 6 functions to heat the preheated long wire material so that a final MMO coating layer is formed, and has an inlet provided on one side thereof for feeding the metal substrate passed through the heat pretreatment furnace 5 and an outlet provided on the other side thereof for discharging the metal substrate heat treated in the heat treatment furnace 6. The heat treatment furnace 6 may have a heating unit such as a heater 6a disposed in a longitudinal direction therein. Also, guide rolls 7 may be disposed under or above the metal substrate between respective devices to guide the metal substrate.

The metal substrate passed through the heat treatment furnace 6 is wound in the form of a coil on the winding reel B thus obtaining a final MMO anode.

The apparatus for continuously manufacturing an MMO anode according to the present invention is particularly adapted to manufacture a long wire type MMO anode having a length of 100 m or more. Even in the case where the total length of the MMO anode is 100 m or more, the apparatus for continuously manufacturing the MMO anode has a structure proper for a reel-to-reel process, and thus the MMO anode may be manufactured even when a manufacturing apparatus which is much smaller in size is used.

Furthermore, because the rate at which the metal substrate is moved from the drawing reel 1 to the winding reel 8 is persistently controlled, the conditions of the coating solution being applied in a longitudinal direction of the metal substrate, and the heat treatment conditions including heat treatment time in the heat pretreatment furnace and the heat treatment furnace may be maintained consistently, thus enabling the formation of a uniform coating layer. Accordingly, the quality of the MMO anode may be improved upon despite it being a long wire type.

Below is a description of a method of manufacturing an MMO anode according to a preferred embodiment of the present invention.

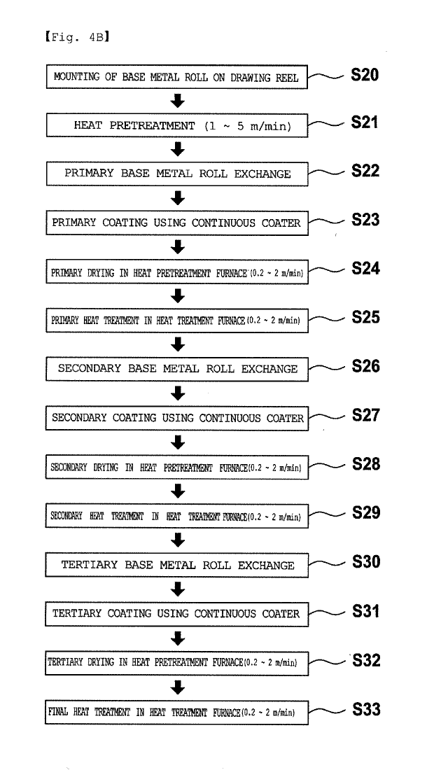

FIG. 4A is a flowchart showing a process of continuously manufacturing the MMO anode according to the present invention. The method of manufacturing the MMO anode according to the present invention may be performed using the apparatus for continuously manufacturing the MMO anode as shown in FIG. 3A or 3B. Specifically, the method of manufacturing the MMO anode according to the present invention is carried out by means of the apparatus for continuously manufacturing the MMO anode using a reel-to-reel process including continuous coating and linear heat treatment.

With reference to FIG. 4A, the method of continuously manufacturing the MMO anode will be sequentially described. First, heat pretreatment is performed before coating the metal substrate with the MMO coating solution. To this end, a metal base roll obtained by winding the metal substrate in the form of a coil is mounted on the drawing reel 1 (S10), and the drawing reel 1 is rotated so that the metal substrate is moved. As such, the MMO coating solution has not yet been supplied on the metal substrate in the continuous coater 3. The metal substrate is preheated in the heat pretreatment furnace 5 (S11), and the metal substrate that passed through the heat pretreatment furnace 5 passes through the heat treatment furnace 6 without being heated. The metal substrate heated in the heat pretreatment furnace 5 is wound on the winding reel 8, and the metal base roll wound on the winding reel 8 is exchanged so as to be mounted again on the drawing reel 1 (S12).

The heat pretreatment (S11) takes place in the heat pretreatment furnace 5 as above, but the present invention is not necessarily limited thereto and the heat pretreatment (S11) may be carried out in the heat treatment furnace 6. In this case, the metal substrate passes through the heat pretreatment furnace 5 without being heated in the heat pretreatment furnace 5.

Alternatively, the heat pretreatment (S11) may be performed in both the heat pretreatment furnace 5 and the heat treatment furnace 6, as necessary.

The heat pretreatment preheats the metal substrate so that the MMO coating solution is uniformly applied on the metal substrate by subsequent continuous coating and heat treatment. This procedure may be carried out in the air atmosphere. The heat pretreatment is performed at 300˜700° C., and upon heat pretreatment, the metal substrate may be transferred at a rate of 1˜5 m/min. If the heat pretreatment is performed under conditions falling outside of the above ranges, the resulting oxide electrode may adversely affect surface roughness, and coatability and uniformity may deteriorate. Hence, the heat pretreatment conditions in the heat pretreatment furnace 5 are limited to the above.

Subsequently, continuous coating and heat treatment (S13˜S15) are carried out. The metal substrate unwound from the drawing reel 1 is passed through the continuous coater 3 so that the surface of the metal substrate is coated with the MMO coating solution (S13). The metal substrate 2 on which the coating solution has been applied via the continuous coater 3 is fed into the heat pretreatment furnace 5 disposed adjacent to the discharge side of the continuous coater 3, and is thus dried in the heat pretreatment furnace 5 (S14). The metal substrate 4 dried in the heat pretreatment furnace 5 is finally heated while passing through the heat treatment furnace 6, thus forming a final MMO coating layer (S15).

The conditions of drying in the heat pretreatment furnace 5 and of heat treatment in the heat treatment furnace 6 may be set so that they vary with preset temperature profiles depending on the thickness and width of the MMO anode, the kind of metal substrate and coating solution, and the thickness of the coating layer. However, taking into consideration the size of a typical long wire type anode, heat pretreatment may be carried out at 300˜700° C. while the metal substrate is transferred at a rate of 0.2˜2 m/min.

The heat treatment plays a role in enhancing the bonding force between the coating solution and the substrate and inducing the efficient growth of the oxide layer. If the heat treatment time is too long, the oxide layer on the surface of titanium grows excessively, undesirably deteriorating electrical conductivity. Also, if a predetermined rate is not maintained, the coating solution may be undesirably stripped from the substrate. Hence, the heat treatment conditions are limited to the above.

The coated metal substrate is wound on the winding reel 8 after having passed through the heat treatment furnace 6, thereby obtaining a long wire type MMO anode in coil form.

The above continuous coating and heat treatment may be repeated at least two times until the coating layer is formed to a set thickness on the surface of the metal substrate.

FIG. 4B is a flowchart showing a manufacturing process in which continuous coating and heat treatment are repeated three times.

With reference to FIG. 4B, a base metal roll comprising a metal substrate wound in coil form is mounted on the drawing reel 1 (S20), and the drawing reel 1 is rotated to move the metal substrate, after which the metal substrate is preheated in the heat pretreatment furnace (or the heat treatment furnace) (S21). Subsequently, primary base metal roll exchange (S22) is carried out, so that the base metal roll comprising the metal substrate wound on the winding reel 8 after heat pretreatment is mounted on the drawing reel 1.

Subsequently, primary continuous coating and heat treatment (S23˜S25) are carried out, and conditions therefor are the same as in S13˜S15 of FIG. 4A. After the primary continuous coating and heat treatment (S23˜S25), secondary base metal roll exchange (S26) and secondary continuous coating and heat treatment (S27˜S29) are carried out. After the secondary continuous coating and heat treatment (S27˜S29), tertiary base metal roll exchange (S30) and tertiary continuous coating and heat treatment (S31˜S33) are conducted. The secondary and tertiary continuous coating and heat treatment may be carried out under primary continuous coating and heat treatment conditions. The metal substrate having the coating layer formed by final heat treatment (S33) in the heat treatment furnace 6 is wound on the winding reel 8 and finally manufactured into a long wire type MMO anode in coil form.

As mentioned above, respective processes of the method of manufacturing the MMO anode using continuous coating and heat treatment according to the present invention are simple, and the exposure time of the MMO anode to the outside between the processes is minimized, thus shortening the process time and increasing the productivity. Furthermore, because the continuous reel-to-reel process is used, a long wire type MMO anode having a length of 100 m or more may be easily manufactured, and the scale of the manufacturing apparatus may be decreased.

Also, it is easy to control movement of the metal substrate at a predetermined rate from the drawing reel 1 to the winding reel 8, and thus the conditions used to supply the coating solution in the longitudinal direction of the metal substrate and the heat treatment conditions of the heat pretreatment furnace and the heat treatment furnace may be kept consistent in a longitudinal direction of the MMO anode, thus enabling the formation of a coating layer that is uniform. The quality of the MMO anode may be increased, despite it being a long wire type.

As described hereinbefore, the present invention provides an apparatus and method for manufacturing an MMO anode using continuous coating and heat treatment. According to the present invention, reel-to-reel continuous coating and heat treatment are used. Even when a long wire type MMO anode is manufactured, continuous coating of a metal substrate with a coating solution and heat treatment thereof under uniform conditions are possible, thus forming a uniform coating layer on the metal substrate, thereby increasing durability and quality performance of the long wire type MMO anode.

Also, according to the present invention, because the MMO anode is manufactured using continuous coating and heat treatment, the exposure time of the metal substrate to the outside between the processes is minimized, and problems of poor productivity attributed to movement between the processes and inconvenient handling can be overcome. Furthermore, the MMO anode can be manufactured using a process that is subject to automatic control, and thus fewer demands are made on manpower, thereby increasing the productivity and decreasing the manufacturing cost, resulting in high product competitiveness.

Although the embodiments of the present invention have been disclosed for illustrative purposes, those skilled in the art will appreciate that a variety of different modifications, additions and substitutions are possible, without departing from the scope and spirit of the invention as disclosed in the accompanying claims. Accordingly, such modifications, additions and substitutions should also be understood as falling within the scope of the present invention.

1. A method of manufacturing an MMO anode using reel-to-reel continuous coating and heat treatment, comprising:
continuously coating a surface of a metal substrate with an MMO (Mixed Metal Oxide) coating solution using a continuous coater; and
passing the metal substrate through a heat pretreatment furnace and a heat treatment furnace to form an MMO coating layer on the surface of the metal substrate.

2. The method of claim 1, wherein the continuously coating is performed using a reel-to-reel dip coating process or a reel-to-reel roll coating process.

3. The method of claim 1, wherein the passing the metal substrate through the heat pretreatment furnace and the heat treatment furnace is continuously performed without interruption.

4. The method of claim 3, wherein the heat pretreatment furnace and the heat treatment furnace are maintained at 300˜700° C., and the metal substrate is continuously transferred at a rate of 1˜5 m/min upon heat pretreatment and the metal substrate is continuously transferred at a rate of 0.2˜2 m/min upon drying in the heat pretreatment furnace and upon heat treatment in the heat treatment furnace.

5. The method of claim 1, wherein the metal substrate is a long wire having a length of 100 m or more.

6. An apparatus for manufacturing an MMO anode using reel-to-reel continuous coating and heat treatment, comprising:
a drawing reel having a metal substrate wound thereon;
a continuous coater for applying a coating solution on a surface of the metal substrate drawn from the drawing reel;
a heat pretreatment furnace disposed adjacent to a discharge side of the continuous coater so that the metal substrate is heat treated after having passed through the continuous coater;
a heat treatment furnace disposed adjacent to a discharge side of the heat pretreatment furnace so that the metal substrate is heat treated after having passed through the heat pretreatment furnace; and
a winding reel disposed adjacent to a discharge side of the heat treatment furnace so that the metal substrate is wound thereon after having passed through the heat treatment furnace.

7. The apparatus of claim 6, wherein the continuous coater comprises a roll coater including an upper roll and a lower roll so that roll coating is performed, or a dip coater so that the metal substrate is dipped in the coating solution in a coating bath by means of a guide roll to perform dip coating.
